(19) United States
(12) Patent Application Publication
(10) Pub. No.: US 2018/0370362 A1
(43) Pub. Date: Dec. 27, 2018

(54) VEHICLE DISPLAY DEVICE

(71) Applicant: Yazaki Corporation, Tokyo (JP)

(72) Inventor: Takeyoshi WATANABE, Shizuoka (JP)

(73) Assignee: Yazaki Corporation, Tokyo (JP)

(21) Appl. No.: 15/991,028

(22) Filed: May 29, 2018

(30) Foreign Application Priority Data
Jun. 27, 2017 (JP) 2017-125116

(51) Int. Cl. B60K 37/02; G02B 27/01

(52) U.S. Cl. CPC B60K 37/02; G02B 27/01; G02B 2027/0161; G02B 2027/011; B60K 2350/2052

(57) ABSTRACT

A vehicle display device includes an opening provided at an upper portion of an instrument panel, and faces a reflection surface disposed above in the vertical direction; a display part that is disposed inside the instrument panel, and projects an image along the vehicle front-rear direction; a first reflection member facing the display part and includes a first free curved surface for reflecting an image; and a second reflection member disposed at a lower side with respect to the first reflection member, placed between the first reflection member and the display part in the vehicle front-rear direction, and includes a second free curved surface for reflecting an image. The second free curved surface faces the opening in the vertical direction.

### CROSS-REFERENCE TO RELATED APPLICATION(S)

The present application claims priority to and incorporates by reference the entire contents of Japanese Patent Application No. 2017-125116 filed in Japan on Jun. 27, 2017.

### BACKGROUND OF THE INVENTION

### 1. Field of the Invention

The present invention relates to a vehicle display device.

### 2. Description of the Related Art

Conventionally, a vehicle display device displays a virtual image using a reflection surface such as a windshield. Japanese Patent Application Laid-open No. 2007-108429 discloses a technology of a head-up display device that reflects display light from a display device toward a windshield using a planar mirror and a concave mirror. The display device, the planar mirror, and the concave mirror in Japanese Patent Application Laid-open No. 2007-108429 are disposed inside an instrument panel.

There is still room for improving the quality of a virtual image. For example, when an image is projected on the windshield and the like after being reflected a plurality of times within the instrument panel, the quality of the virtual image may be deteriorated due to aberration. It is preferable to improve the quality of a virtual image while the image is reflected a plurality of times within a limited space inside the instrument panel.

### SUMMARY OF THE INVENTION

An object of the present invention is to provide a vehicle display device that can improve the quality of a virtual image.

A vehicle display device according to one aspect of the present invention includes an opening that is provided at an upper portion of an instrument panel of a vehicle, and faces a reflection surface disposed above the instrument panel in a vertical direction; a display part that is disposed inside the instrument panel, and that projects an image along a front-rear direction of the vehicle; a first reflection member that is disposed inside the instrument panel, that faces the display part in the front-rear direction of the vehicle, and that includes a first free curved surface for reflecting an image; and a second reflection member that is disposed at a lower side with respect to the first reflection member inside the instrument panel, that is placed between the first reflection member and the display part in the front-rear direction of the vehicle, and that includes a second free curved surface for reflecting an image, wherein the second free curved surface faces the opening in the vertical direction, an image projected from the display part is sequentially reflected by the first free curved surface, the second free curved surface, and the reflection surface, and is projected toward an eye point of the vehicle, and the second free curved surface functions as a correcting reflection surface for correcting field curvature.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicle display device according to an embodiment;

FIG. 2 is a sectional view of the vehicle display device according to the embodiment;

FIG. 3 is a sectional view illustrating how optical paths are shared in the embodiment;

FIG. 4 is another sectional view illustrating how optical paths are shared in the embodiment;

FIG. 5 is still another sectional view illustrating how optical paths are shared in the embodiment;

FIG. 6 is a sectional view illustrating an area shared by three optical paths in the embodiment;

FIG. 7 is a sectional view of a display unit of a comparative example;

FIG. 8 is a sectional view of a display unit according to a first modification of the embodiment; and

FIG. 9 is a sectional view of a display unit according to a second modification of the embodiment.

### DETAILED DESCRIPTION OF THE PREFERRED EMBODIMENTS

Hereinafter, a vehicle display device according to an embodiment of the present invention will be described in detail with reference to the accompanying drawings. It is to be understood that the present invention is not limited to this embodiment. Moreover, components in the following embodiment include components that can be easily conceived by those skilled in the art, or components substantially the same as those components.

### Embodiment

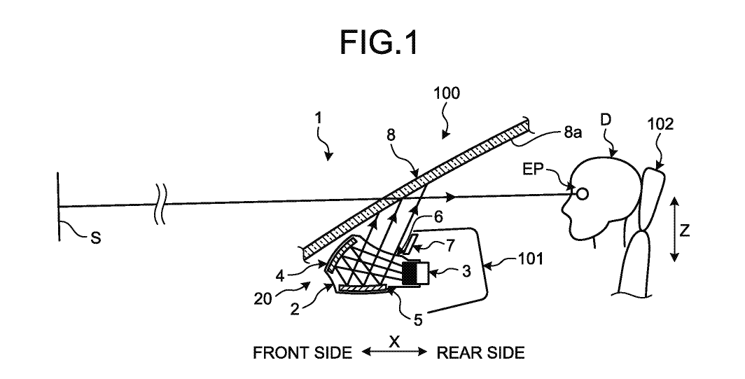

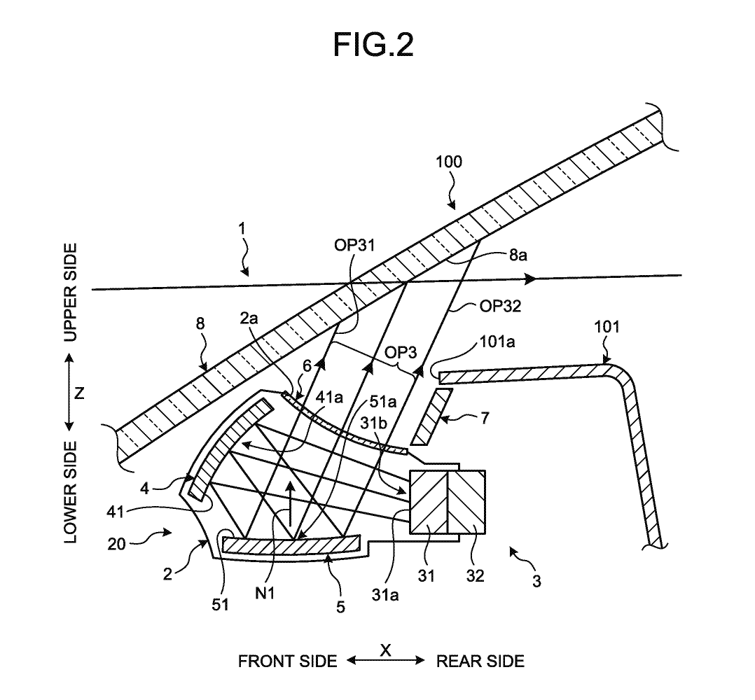

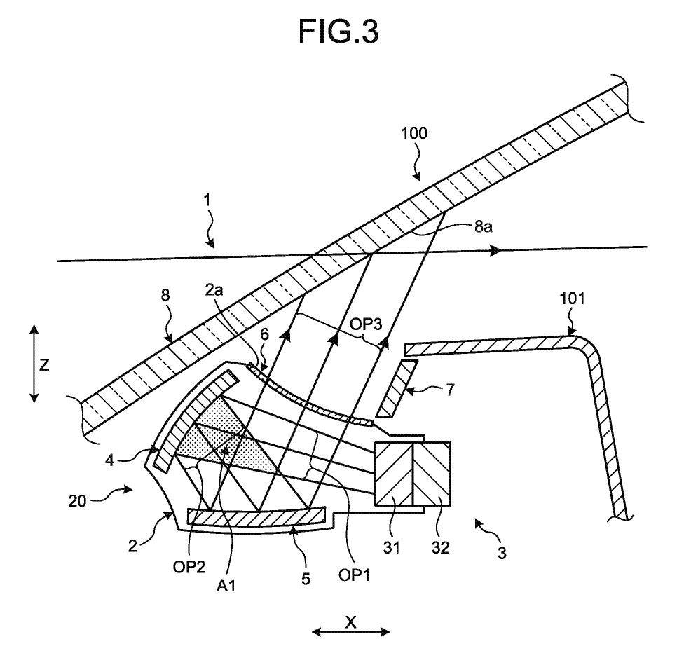

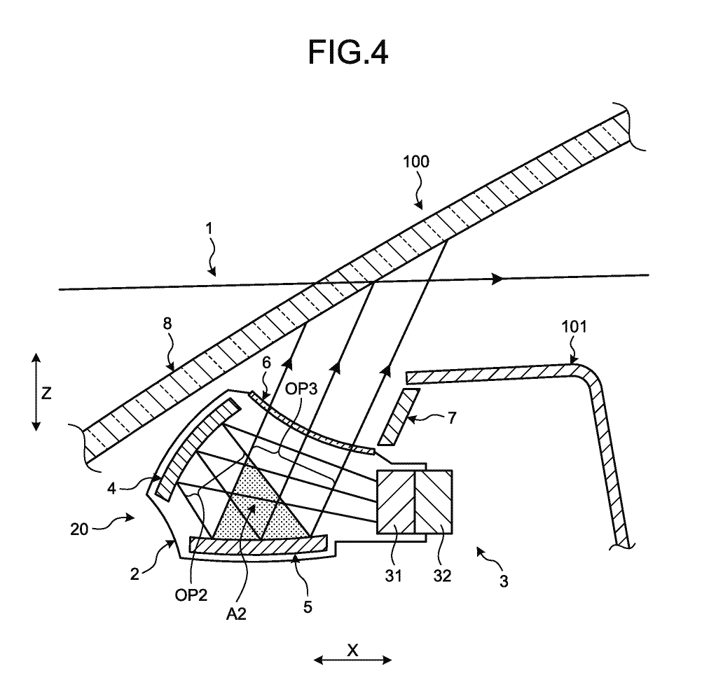

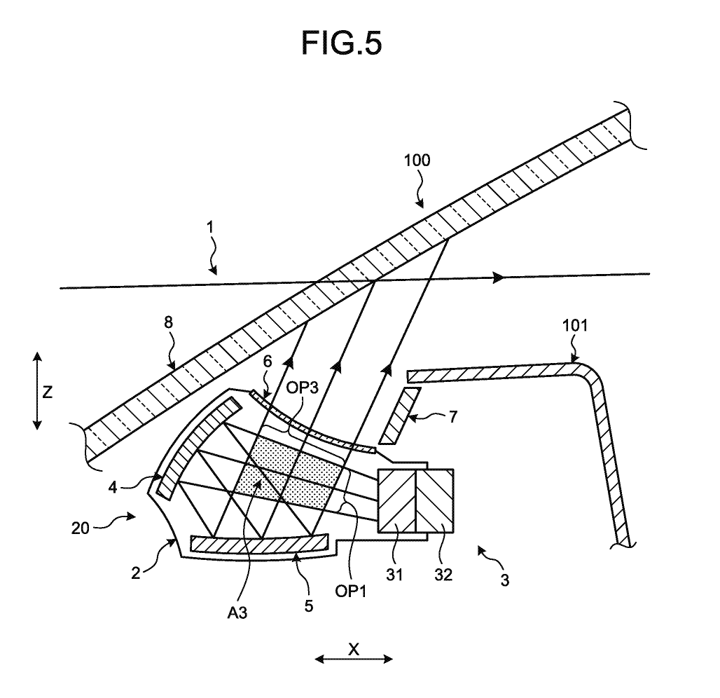

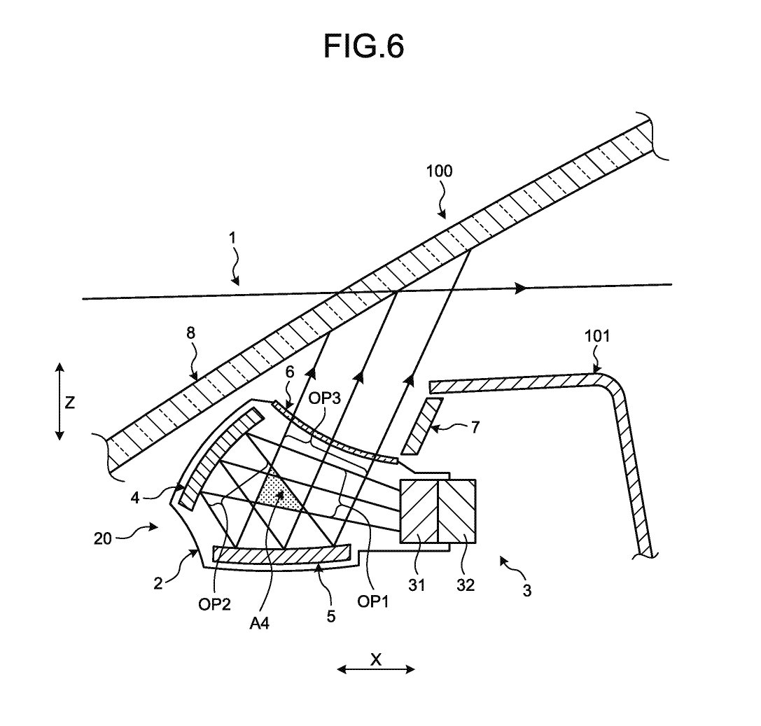

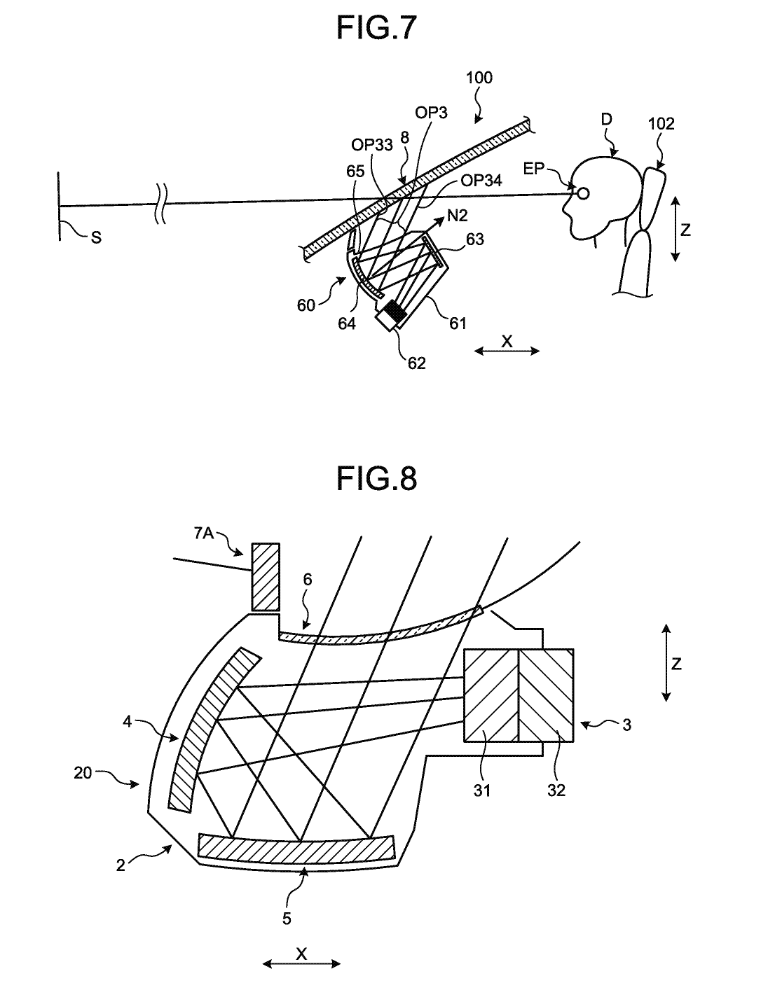

An embodiment will now be described with reference to FIG. 1 to FIG. 7. The present embodiment relates to a vehicle display device. FIG. 1 is a schematic configuration diagram of the vehicle display device according to the embodiment. FIG. 2 is a sectional view of the vehicle display device according to the embodiment. FIG. 3 is a sectional view illustrating how optical paths are shared in the embodiment. FIG. 4 is another sectional view illustrating how optical paths are shared in the embodiment. FIG. 5 is still another sectional view illustrating how optical paths are shared in the embodiment. FIG. 6 is a sectional view illustrating an area shared by three optical paths in the embodiment. FIG. 7 is a sectional view of a display unit of a comparative example.

As illustrated in FIG. 1, a vehicle display device 1 according to the present embodiment includes a display unit 20 and a windshield 8 as a reflection surface. The vehicle display device 1 of the present embodiment is what is called a head-up display (HUD) device. The vehicle display device 1 can display an image by overlapping a virtual image S with the scene in front of a vehicle 100. However, the display mode of the virtual image S by the vehicle display device 1 is not limited thereto, and for example, the virtual image may also be displayed on the surrounding area of the front scene, such as at a lower portion or an upper portion of the windshield 8.

The windshield 8 is a glass member that partitions between the interior and the exterior of the vehicle 100. The windshield 8 has a translucent property that reflects a part of incident light and that allows the other part of the incident light to pass through. More specifically, the windshield 8 reflects the light from the head-up display (HUD) device to an eye point EP of a driver D, while allowing the front scene of the vehicle 100 to be viewed. For example, a translucent coating is applied to the windshield 8. The translucent coating is applied to a surface (hereinafter, simply referred to as an “inside surface”) 8a at the vehicle interior side of the windshield 8. The inside surface 8a is a reflection surface that reflects the light projected from the display unit 20 toward the eye point EP side. The windshield 8 is disposed above an instrument panel 101 of the vehicle 100.

The instrument panel 101 is placed in front of a driver's seat 102 in the vehicle interior. Thus, the instrument panel 101 is placed in front of the driver D who has seated on the driver's seat 102 in a vehicle front-rear direction X. The display unit 20 is disposed inside the instrument panel 101, in other words, in a space portion surrounded by the instrument panel 101. As illustrated in FIG. 2, an opening 101a is provided at the upper portion of the instrument panel 101. The opening 101a is formed on a wall that covers the upper surface of the instrument panel 101, in other words, the inner space of the instrument panel 101 from the upper side. The opening 101acommunicatively connects between the space inside the instrument panel 101 and the outside space in a vehicle vertical direction Z. The opening 101a faces the inside surface 8a of the windshield 8 in the vehicle vertical direction Z.

The display unit 20 includes a housing unit 2, a display part 3, a first reflection member 4, a second reflection member 5, a cover 6, and a shielding wall 7. The housing unit 2 is disposed inside the instrument panel 101. The housing unit 2 is disposed in a space surrounded by the instrument panel 101, and is fixed to a vehicle body. The housing unit 2 is a box-like member formed of metal, synthetic resin, and the like. The size of the housing unit 2 of the present embodiment in the vehicle vertical direction Z is gradually reduced from the front side toward the rear side in the vehicle front-rear direction X. The upper surface of the housing unit 2 is gradually inclined downward from the vehicle front side toward the vehicle rear side.

The display part 3 is an image projection device that displays an image and that projects the image. The display part 3 is disposed at the rear end portion of the housing unit 2 in the vehicle front-rear direction X. The display part 3 is held by the wall of the housing unit 2 at the rear end side. The rear end of the display part 3 may be exposed toward the rear side from the housing unit 2. The display part 3 of the present embodiment includes a liquid crystal display part 31 and a backlight unit 32. For example, the liquid crystal display part 31 is a thin film transistor-liquid crystal display (TFT-LCD). The liquid crystal display part 31 can generate any image and display the image.

The backlight unit 32 is disposed at the back surface side of the liquid crystal display part 31. In the present embodiment, the back surface side of the liquid crystal display part 31 is the rear side in the vehicle front-rear direction X. The backlight unit 32 irradiates the liquid crystal display part 31 with light from the back surface side. An image displayed by the liquid crystal display part 31 is projected toward the front surface side by the light of the backlight unit 32. In the display part 3 of the present embodiment, the liquid crystal display part 31 is disposed so as to face the front side in the vehicle front-rear direction X. Consequently, the display part 3 projects an image toward the front side in the vehicle front-rear direction X. As illustrated in FIG. 2, the display part 3 of the present embodiment is configured so as to project an image slightly upward than the vehicle front-rear direction X (typically, the horizontal direction).

The first reflection member 4 is a member that reflects the image projected from the display part 3 downward in the vehicle vertical direction Z. The first reflection member 4 is disposed at the front end portion of the housing unit 2 in the vehicle front-rear direction X. The first reflection member 4 is held by the wall of the housing unit 2 at the front end side. The first reflection member 4 faces the liquid crystal display part 31 of the display part 3 in the vehicle front-rear direction X. The first reflection member 4 includes a first free curved surface 41 for reflecting an image. The first free curved surface 41 faces the rear side in the vehicle front-rear direction X, and faces an image display surface 31a of the liquid crystal display part 31 in the vehicle front-rear direction X. The first reflection member 4 is disposed slightly above the display part 3. More specifically, a center 41a of the first free curved surface 41 is placed higher than a center 31b of the image display surface 31a in the vehicle vertical direction Z.

The first free curved surface 41 is a free curved surface, and is a curved surface curved with different curvatures depending on the location of the surface, for example. The first free curved surface 41 reflects light projected from the liquid crystal display part 31 toward the second reflection member 5. The first free curved surface 41 of the present embodiment functions as a magnifying reflection surface that magnifies and reflects an image, and functions as a correcting reflection surface that corrects the image. For example, the shape of the first free curved surface 41 is defined so as to correct the reflection angle of light and the optical path length of light. For example, the first free curved surface 41 is configured so as to prevent aberration from occurring and to reduce the degree of aberration. The first free curved surface 41 magnifies an image projected from the liquid crystal display part 31 and reflects the image toward the second reflection member 5. Moreover, the first free curved surface 41 corrects the distortion, aberration, and the like of the image projected from the liquid crystal display part 31, and reflects the image toward the second reflection member 5.

The second reflection member 5 is a reflection member that reflects the incident light from the first reflection member 4 toward the windshield 8. The second reflection member 5 includes a second free curved surface 51 for reflecting light. The second reflection member 5 is disposed such that the second free curved surface 51 faces upward in the vehicle vertical direction Z. The second reflection member 5 is disposed at the lower end portion of the housing unit 2 in the vehicle vertical direction Z. The second reflection member 5 is held by the wall of the housing unit 2 at the lower end side. Moreover, the second reflection member 5 is disposed at a lower side with respect to the first reflection member 4. More specifically, for example, the second reflection member 5 is disposed such that the second free curved surface 51 is placed below the lower end of the first reflection member 4 in the vehicle vertical direction Z.

The second reflection member 5 is placed between the first reflection member 4 and the display part 3 in the vehicle front-rear direction X. More specifically, a center 51a of the second free curved surface 51 is placed between the center 41a of the first free curved surface 41 and the center 31b of the image display surface 31a in the vehicle front-rear direction X. In the present embodiment, the center 51a of the second free curved surface 51 is placed slightly closer to the center 41a than the halfway position between the center 41a and the center 31b.

An opening 2a is provided at the upper portion of the housing unit 2. The opening 2a is formed on the wall at the upper side of the housing unit 2. The opening 2a is provided at a position corresponding to the opening 101a of the instrument panel 101. In other words, when viewed in the vehicle vertical direction Z, the opening 2a and the opening 101a are overlapped with each other. The internal space of the housing unit 2 is communicably connected with the external space of the instrument panel 101 via the opening 2a and the opening 101a. The opening 2a faces the inside surface 8a of the windshield 8 in the vehicle vertical direction Z.

The cover 6 is closing the opening 2a. The cover 6 is a plate-shaped member having a light-transmitting property. For example, the cover 6 is formed of synthetic resin such as acrylic and glass. The cover 6 is gently curved toward the space inside the housing unit 2. The shielding wall 7 is disposed at the rear side of the cover 6 in the vehicle front-rear direction X. The cover 6 reflects the external light entering from the windshield 8 side toward the shielding wall 7. This prevents the external light from hitting the liquid crystal display part 31. The shielding wall 7 is a member having a low reflectivity. The shielding wall 7 suppresses the dispersion of external light, by absorbing the external light reflected by the cover 6 and the like.

The image reflected by the second reflection member 5 passes through the space between the display part 3 and the first reflection member 4, passes through the cover 6, and enters the inside surface 8a of the windshield 8. As illustrated in FIG. 1, the inside surface 8a reflects an image toward the rear side in the vehicle front-rear direction X. More specifically, the display unit 20 is configured such that the inside surface 8a reflects an image toward the eye point EP of the vehicle 100. In other words, the incident angle of the light that enters the inside surface 8a from the display unit 20 is set so that the reflection light is directed toward the eye point EP. The eye point EP is defined in advance as a viewing position of the driver D who is seated on the driver's seat 102.

The image projected by the display part 3 is sequentially reflected by the first reflection member 4, the second reflection member 5, and the inside surface 8a of the windshield 8. The image reflected toward the driver D in this manner is formed as the virtual image S when viewed from the driver D. The position where the virtual image S is formed is the position in front of the windshield 8 in the vehicle front-rear direction X. In other words, the driver D recognizes as if an actual image is displayed at the position in front of the windshield 8. For example, the virtual image S is displayed such that the virtual image S is overlapped with a movable body in front of the vehicle 100, the road surface, and the like.

The second reflection member 5 of the present embodiment is disposed in a substantially horizontal manner. In the second reflection member 5, the direction of a normal line N1 at the center 51a of the second free curved surface 51 is along the vehicle vertical direction Z, and is aligned with the vehicle vertical direction Z, for example. The vehicle display device 1 of the present embodiment can advantageously reduce aberration as will be described below. The advantage will now be described with reference to a comparative example. A display unit 60 of the comparative example is illustrated in FIG. 7. The display unit 60 of the comparative example includes a housing unit 61, a display part 62, a first reflection member 63, a second reflection member 64, and a cover 65. The first reflection member 63 of the comparative example is a planar mirror. The second reflection member 64 is a free curved surface mirror. The display unit 60 of the comparative example reflects an image so that the optical path is formed in the shape of a letter N or Z.

More specifically, the display part 62 is disposed at the lowest portion of the housing unit 61. The first reflection member 63 is disposed at the rear side of the display part 62 in the vehicle front-rear direction X, and above the display part 62 in the vehicle vertical direction Z. The second reflection member 64 is disposed in front of the first reflection member 63 in the vehicle front-rear direction X, and faces the first reflection member 63 in the vehicle front-rear direction X. The display part 62 projects an image in an oblique upward direction. The first reflection member 63 reflects an image toward the front side in the vehicle front-rear direction X. The second reflection member 64 reflects the light entering from the first reflection member 63 toward the windshield 8.

When the optical path is formed in a zigzag pattern in this manner, the variation of the optical path length of the optical path from the second reflection member 64 to the windshield 8 tends to increase. The angle and the arrangement of the reflection members 63 and 64 are defined so that the windshield 8 reflects an image toward the eye point EP. For example, in the second reflection member 64, the direction of a normal line N2 at the center of the reflection surface is inclined toward the rear side in the vehicle front-rear direction X. In FIG. 7, the normal line N2 is substantially in parallel with the windshield 8. Consequently, in an optical path (hereinafter, referred to as a “third optical path”) OP3 directed toward the windshield 8 from the second reflection member 64, a difference between the optical path length of an optical path OP33 at the vehicle front side and the optical path length of an optical path OP34 at the vehicle rear side is increased.

Alternatively, as illustrated in FIG. 2, in the third optical path OP3 directed toward the windshield 8 from the second reflection member 5 in the display unit 20 of the present embodiment, a difference between the optical path length of an optical path OP31 at the vehicle front side and the optical path length of an optical path OP32 at the vehicle rear side is less likely increased. Consequently, the vehicle display device 1 of the present embodiment advantageously reduces the aberration and improves the quality of the virtual image S.

The second reflection member 5 at least functions as the correcting reflection surface for correcting an image. The second reflection member 5 of the present embodiment functions as the correcting reflection surface as well as the magnifying reflection surface. The shape and the curvature of the second free curved surface 51 of the second reflection member 5 of the present embodiment are defined so as to at least suppress field curvature and correct the field curvature. The variation and deviation of the optical path length in the third optical path OP3 directed toward the windshield 8 from the second reflection member 5 are small. Consequently, a degree of correction required for the second free curved surface 51 will be reduced. As a result, the degree of freedom in optically designing the second free curved surface 51 is advantageously improved. Moreover, the optical path length deviation of the third optical path OP3 is small. Thus, the second free curved surface 51 can more effectively reduce the field curvature. For example, in the optical path from the second free curved surface 51 to the eye point EP, the quality of the virtual image S is less likely deteriorated by aberration. Consequently, the vehicle display device 1 of the present embodiment can advantageously improve the quality of the virtual image S. The vehicle display device 1 of the present embodiment can easily correspond even if the display range of the virtual image S is increased or the virtual image S is formed at a position further away, while maintaining the quality of the virtual image S.

The optical path of the vehicle display device 1 of the present embodiment is formed in an α shape.

Consequently, as will be described below, the size of the device can be reduced by increasing the shared space of the optical paths. As illustrated in FIG. 3, when viewed from the vehicle width direction, an optical path (hereinafter, referred to as a “first optical path”) OP1 directed toward the first reflection member 4 from the liquid crystal display part 31, an optical path (hereinafter, referred to as a “second optical path”) OP2 directed toward the second reflection member 5 from the first reflection member 4, and the third optical path OP3 are intersecting with each other so as to form the a shape. In this manner, because the optical paths OP1, OP2, and OP3 are intersecting with each other, the first optical path OP1 and the second optical path OP2 share a first area A1. The first area A1 is a part of the first optical path OP1 as well as a part of the second optical path OP2.

Moreover, as illustrated in FIG. 4, the second optical path OP2 and the third optical path OP3 share a second area A2. Furthermore, as illustrated in FIG. 5, the first optical path OP1 and the third optical path OP3 share a third area A3. In other words, the first optical path OP1 shares the area A1 with the second optical path OP2, and shares the area A3 with the third optical path OP3. The second optical path OP2 shares the first area A1 with the first optical path OP1, and shares the second area A2 with the third optical path OP3. The third optical path OP3 shares the third area A3 with the first optical path OP1, and shares the second area A2 with the second optical path OP2. In this manner, each of the three optical paths OP1, OP2, and OP3 has a portion overlapping with the other two optical paths, when viewed from the vehicle width direction. Consequently, it is possible to secure the necessary optical path length by effectively using the space inside the housing unit 2.

Furthermore, in the present embodiment, as illustrated in FIG. 6, the three optical paths OP1, OP2, and OP3 share one area A4. In this manner, because the three optical paths OP1, OP2, and OP3 are overlapped with each other in the area A4, the space inside the housing unit 2 is used more effectively.

Still furthermore, in the present embodiment, it is possible to reduce the incident angle and the reflection angle of the light relative to the first free curved surface 41. First, a problem that may occur in the comparative example will be described. In the display unit 60 of the comparative example illustrated in FIG. 7, the second reflection member 64 is extending in the vehicle vertical direction Z. The display part 62 is arranged so as not to interfere with the second reflection member 64. As a result, a degree of freedom in arranging the display part 62 is reduced. In the display unit 60 of the comparative example, the display part 62 is disposed below the second reflection member 64 so as to avoid the interference with the second reflection member 64. The display part 62 may also be disposed so that the display part 62 is shifted from the second reflection member 64 in the vehicle width direction. In this manner, because the arrangement is restricted, the display part 62 projects an image to the first reflection member 63 from the oblique direction. As a result, the virtual image S tends to be distorted by aberration and the like.

Alternatively, as illustrated in FIG. 2, in the display unit 20 of the present embodiment, the image display surface 31a can be easily disposed at the position close to the immediate front of the first free curved surface 41. In this manner, because the second reflection member 5 is extending in the horizontal direction, and is disposed at the bottom of the housing unit 2, the first reflection member 4 and the display part 3 can be disposed in the internal space of the housing unit 2 with a high degree of freedom. The display part 3 can be easily disposed such that the incident angle of the light from the display part 3 at the first reflection member 4, and the reflection angle of the light reflecting toward the second reflection member 5 are reduced. Consequently, the vehicle display device 1 of the present embodiment can improve the quality of the virtual image S.

As described above, the vehicle display device 1 of the present embodiment includes the opening 101a, the display part 3, the first reflection member 4, and the second reflection member 5. The opening 101a is provided at the upper portion of the instrument panel 101 in the vehicle 100, and facing the reflection surface (inside surface 8a) disposed above the instrument panel 101 in the vehicle vertical direction Z. The display part 3 is disposed inside the instrument panel 101, and projects an image along the vehicle front-rear direction X.

The first reflection member 4 is disposed inside the instrument panel 101, and faces the display part 3 in the vehicle front-rear direction X. The first reflection member 4 includes the first free curved surface 41 for reflecting an image.

The second reflection member 5 is disposed below the first reflection member 4 in the instrument panel 101. The second reflection member 5 is placed between the first reflection member 4 and the display part 3 in the vehicle front-rear direction X. The second reflection member 5 includes the second free curved surface 51 for reflecting an image. The second free curved surface 51 faces the opening 101a of the instrument panel 101 in the vehicle vertical direction Z. In other words, the second free curved surface 51 faces the inside surface 8a of the windshield 8 with the opening 101a interposed therebetween in the vehicle vertical direction Z.

In the vehicle display device 1, an image projected from the display part 3 is sequentially reflected by the first free curved surface 41, the second free curved surface 51, and the inside surface 8a, and is projected toward the eye point EP of the vehicle 100. The second free curved surface 51 functions as a correcting reflection surface for correcting field curvature.

In the vehicle display device 1 of the present embodiment, the deviation of the optical path length of the optical path (third optical path OP3) between the second free curved surface 51 serving as the correcting reflection surface and the windshield 8 is small. Consequently, the vehicle display device 1 of the present embodiment can suppress the distortion of the virtual image S due to aberration and the like, and improve the quality of the virtual image S.

Moreover, the vehicle display device 1 of the present embodiment reflects an image by the two free curved surfaces 41 and 51. Thus, it is possible to suitably assign the correction function and the magnification function to the two free curved surfaces 41 and 51. For example, the first free curved surface 41 may mainly have a magnification function. For example, the second free curved surface 51 may mainly have a correction function. The first free curved surface 41 may be a reflection surface dedicated to a magnification function. The second free curved surface 51 may be a reflection surface dedicated to a correction function. In this manner, by including the two free curved surfaces 41 and 51, a degree of freedom in optical design is improved. Consequently, the vehicle display device 1 of the present embodiment can advantageously improve the quality of the virtual image S.

Furthermore, in the vehicle display device 1 of the present embodiment, the second free curved surface 51 is a surface facing upward. The second free curved surface 51 reflects the image reflected downward by the first free curved surface 41 in the upward direction. With such a reflection configuration, it is possible to easily dispose the second free curved surface 51 nearly parallel to the windshield 8.

Still furthermore, in the vehicle display device 1 of the present embodiment, the direction of the normal line N1 at the center 51a of the second free curved surface 51 is in the vertical direction. The direction of the normal line N1 may be aligned with the vehicle vertical direction Z, and may be substantially aligned with the vehicle vertical direction Z. When the direction of the normal line N1 is defined in this manner, it is possible to easily dispose the second free curved surface 51 nearly parallel to the windshield 8. Such a configuration is particularly advantageous when the inclination angle of the windshield 8 relative to the vehicle vertical direction Z is large.

In the vehicle display device 1 of the present embodiment, when viewed from the vehicle width direction of the vehicle 100, the first optical path OP1, the second optical path OP2, and the third optical path OP3 each have a portion overlapping with the other two optical paths.

For example, as illustrated in FIG. 3, the first optical path OP1 has a portion (first area Al) overlapping with the second optical path OP2. As illustrated in FIG. 5, the first optical path OP1 also has a portion (third area A3) overlapping with the third optical path OP3. The same applies for the other two optical paths OP2 and OP3. Consequently, the vehicle display device 1 of the present embodiment can reduce the volume of the housing unit 2, while securing the necessary optical path length in the internal space of the housing unit 2.

### First Modification of Embodiment

A first modification of the embodiment will now be described. FIG. 8 is a sectional view of a display unit according to the first modification of the embodiment. A main difference between the first modification of the embodiment and the embodiment described above is the arrangement of a shielding wall 7A. With the display unit 20 of the first modification, the shielding wall 7A is disposed in front of the cover 6 in the vehicle front-rear direction X. The cover 6 is configured so as to reflect the external light entered from the windshield 8 side toward the shielding wall 7A. In this manner, with the display unit 20, a degree of freedom in arranging the shielding walls 7 and 7A is high. Thus, the display unit 20 is easily adapted to the mounting requirements of the vehicle 100. The display part 31 according to the first modification of the embodiment projects an image slightly downward relative to the vehicle front-rear direction X.

### Second Modification of Embodiment

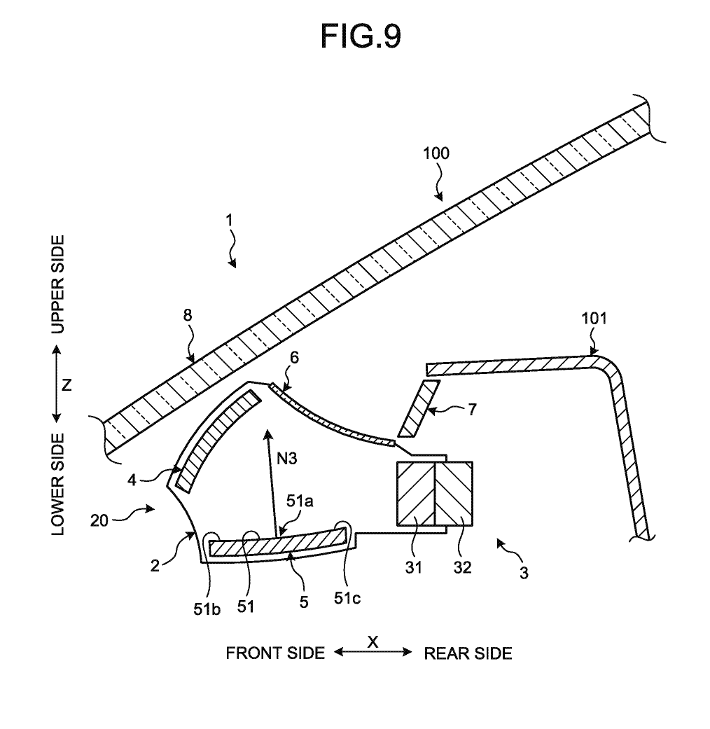

A second modification of the embodiment will now be described. FIG. 9 is a sectional view of a display unit according to the second modification of the embodiment. As illustrated in FIG. 9, in the display unit 20 according to the second modification of the embodiment, a normal line N3 of the second reflection member 5 is inclined toward the front in the vehicle front-rear direction X. The normal line N3 is a normal line at the center 51a of the second free curved surface 51. A rear end 51c of the second free curved surface 51 is placed higher than a front end 51b in the vehicle vertical direction Z. In this manner, because the second free curved surface 51 is inclined relative to the vehicle front-rear direction X, the positional relation between the second free curved surface 51 and the windshield 8 tends to become nearly parallel.

### Third Modification of Embodiment

The display unit 20 may be configured such that the display part 3 projects an image toward the rear side in the vehicle front-rear direction X. For example, in the embodiment described above (FIG. 2), the first reflection member 4 is disposed in front of the display part 3 in the vehicle front-rear direction X. Alternatively, the first reflection member 4 may be disposed at the rear side of the display part 3 in the vehicle front-rear direction X. In this case, the liquid crystal display part 31 in the display part 3 is disposed toward the rear in the vehicle front-rear direction X. Similar to the embodiment described above, the second reflection member 5 is disposed between the first reflection member 4 and the display part 3 in the vehicle front-rear direction X. Similar to the embodiment described above, an image is sequentially reflected by the first free curved surface 41, the second free curved surface 51, and the inside surface 8a of the windshield 8.

In the embodiment described above, the two free curved surfaces 41 and 51 both function as the magnifying reflection surface and the correcting reflection surface. However, the function of the two free curved surfaces 41 and 51 is not limited thereto. For example, the second free curved surface 51 may function as the correcting reflection surface but need not function as the magnifying reflection surface. The first free curved surface 41 may only function as one of the magnifying reflection surface and the correcting reflection surface, and may not function as the other.

The reflection surface is not limited to the windshield 8. For example, the reflection surface may also be a combiner provided separately from the windshield 8 and the like. The display part 3 may display an image by a display device other than the liquid crystal display part 31.

The contents disclosed in the embodiment and the modifications described above may be implemented by a suitable combination.

The vehicle display device according to the present embodiments includes an opening that is provided at the upper portion of the instrument panel of the vehicle, and that faces the reflection surface disposed above the instrument panel in the vertical direction; a display part that is disposed inside the instrument panel, and that projects an image along the front-rear direction of the vehicle; a first reflection member that is disposed inside the instrument panel, that faces the display part in the front-rear direction of the vehicle, and that includes the first free curved surface for reflecting an image; and a second reflection member that is disposed at a lower side with respect to the first reflection member inside the instrument panel, that is placed between the first reflection member and the display part in the front-rear direction of the vehicle, and that includes the second free curved surface for reflecting an image.

The second free curved surface faces the opening in the vertical direction. In the vehicle display device, an image projected from the display part is sequentially reflected by the first free curved surface, the second free curved surface, and the reflection surface, and is projected toward the eye point of the vehicle. The second free curved surface functions as the correcting reflection surface for correcting field curvature. In the vehicle display device according to the present embodiments, the second free curved surface faces the opening of the instrument panel in the vertical direction. Thus, deviation of the optical path length of the optical path from the second free curved surface to the reflection surface is small. Consequently, the vehicle display device according to the present embodiments can advantageously improve the quality of a virtual image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device, comprising:
an opening that is provided at an upper portion of an instrument panel of a vehicle, and faces a reflection surface disposed above the instrument panel in a vertical direction;
a display part that is disposed inside the instrument panel, and that projects an image along a front-rear direction of the vehicle;
a first reflection member that is disposed inside the instrument panel, that faces the display part in the front-rear direction of the vehicle, and that includes a first free curved surface for reflecting an image; and
a second reflection member that is disposed at a lower side with respect to the first reflection member inside the instrument panel, that is placed between the first reflection member and the display part in the front-rear direction of the vehicle, and that includes a second free curved surface for reflecting an image, wherein
the second free curved surface faces the opening in the vertical direction,
an image projected from the display part is sequentially reflected by the first free curved surface, the second free curved surface, and the reflection surface, and is projected toward an eye point of the vehicle, and
the second free curved surface functions as a correcting reflection surface for correcting field curvature.

2. The vehicle display device according to claim 1, wherein
the second free curved surface is a surface facing upward, and reflects an image reflected downward by the first free curved surface in an upward direction.

3. The vehicle display device according to claim 1, wherein
a direction of a normal line at a center of the second free curved surface is the vertical direction.

4. The vehicle display device according to claim 2, wherein
a direction of a normal line at a center of the second free curved surface is the vertical direction.

5. The vehicle display device according to claim 1, wherein
when viewed from a vehicle width direction of the vehicle, an optical path of an image directed toward the first free curved surface from the display part, an optical path of an image directed toward the second free curved surface from the first free curved surface, and an optical path of an image directed toward the reflection surface from the second free curved surface each have a portion overlapping with the other two optical paths.

6. The vehicle display device according to claim 2, wherein
when viewed from a vehicle width direction of the vehicle, an optical path of an image directed toward the first free curved surface from the display part, an optical path of an image directed toward the second free curved surface from the first free curved surface, and an optical path of an image directed toward the reflection surface from the second free curved surface each have a portion overlapping with the other two optical paths.

7. The vehicle display device according to claim 3, wherein
when viewed from a vehicle width direction of the vehicle, an optical path of an image directed toward the first free curved surface from the display part, an optical path of an image directed toward the second free curved surface from the first free curved surface, and an optical path of an image directed toward the reflection surface from the second free curved surface each have a portion overlapping with the other two optical paths.
